(19) United States
(12) Patent Application Publication
(10) Pub. No.: US 2015/0064466 A1
(43) Pub. Date: Mar. 5, 2015

(54) POLYBUTENE-1 RESIN FOR ADHESION MODIFICATION OF CABLES

(71) Applicant: Equistar Chemicals, LP, Houston, TX (US)

(72) Inventors: Cindy Flenniken, Clarksville, OH (US); Chun D. Lee, Cincinnati, OH (US)

(73) Assignee: Equistar Chemicals, LP, Houston, TX (US)

(21) Appl. No.: 14/018,864

(22) Filed: Sep. 5, 2013

(51) Int. Cl. H01B 7/00; H01B 7/02

(52) U.S. Cl. CPC H01B 7/00; H01B 7/0275; H01B 7/0283
USPC 428/392; 427/118; 156/52

(57) ABSTRACT

An insulated electrical cable having: (a) an electrically conductive core; and (b) a semiconductive shield containing a composition made from and/or containing a butene-1 polymer composition, an ethylene copolymer composition, and a conductive carbon black composition is provided. The semiconductive shield is formed over the electrically conductive core. A method for making insulated electrical cables and a method for making a medium voltage electric power cables is also provided.

### FIELD OF THE INVENTION

This invention relates to an electrical cable. Specifically, it relates to an insulated electrical cable having a semiconductive shield over an electrically conductive core, where the shield is formed from a composition made from and/or containing a butene-1 polymer composition, an ethylene copolymer composition, and a conductive carbon black composition.

The present invention also relates to a method of manufacturing the insulated electrical cable including the steps of (a) extruding the semiconductive shield over the electrically conductive core, (b) extruding an insulation layer over the semiconductive shield and optionally, (c) extruding a semiconductive layer over the insulation layer.

### DESCRIPTION OF RELATED ART

A typical insulated electric power cable generally comprises a conductive core that is surrounded by several layers of polymeric materials including an inner semiconductive shield layer (known as a conductor shield, conductor screen, core shield, core screen shield, or strand shield), an insulating layer, an outer semiconductive shield layer (known as an insulation shield or insulation screen), a metallic wire or tape shield used as the ground phase, and a protective jacket. The semiconductive shield layers are also commonly referred to as “semiconducting” dielectric shields. Additional layers within this construction such as moisture impervious materials are often incorporated.

The primary purpose of the inner semiconductive conductor shield (or conductor shield) is to provide a smooth interface with the insulation to reduce the stress concentration at this boundary and hence ensure the long term viability of the primary insulation. There is always a need for improved semiconductive conductor shield compositions that balance cost and performance.

In general, semiconductive insulation shields can be classified into two distinct types, the first type being a type wherein the insulation shield is securely bonded to the polymeric insulation so that stripping the insulation shield is only possible by using a cutting tool that removes the insulation shield along with some of the cable insulation. This type of insulation shield is preferred by companies that believe that this adhesion minimizes the risk of electric breakdown at the interface of the insulation and the insulation shield.

The second type of insulation shield is the “strippable” insulation shield wherein the insulation shield has a defined, limited, adhesion to the insulation so that the strippable insulation shield can be peeled cleanly away from the insulation without removing any insulation.

High performance semiconductive conductor shield compositions that include an ethylene/vinyl acetate copolymer, acetylene carbon black, and an organic peroxide crosslinking agent are often used for these applications. Vinyl acetate resins, however, may only be used with aluminum conductors because they are corrosive to copper conductors. Furthermore, high loadings of acetylene black combined with ethylene/vinyl acetate resin lead to the formation of acids in the extruder which then corrode and abrade extrusion die tooling, resulting in cable dimension variations over time.

Semiconductive conductor shield compositions containing acetylene black and an ethylene/ethylacrylate copolymer often demonstrate “shrinkback” on the cable. Shrinkback is a condition that occurs when the semiconductive conductor shield and the insulation anneal and shrink following cable manufacture. Shrinkback causes the semiconductive shield to lose its adhesion to the conductor. As a result, the conductor protrudes out of the cable core, thus diminishing the integrity of the cable system, particularly at splices.

Insulation layers are commonly prepared from compositions made from and/or containing polyethylene, crosslinked polyethylenes, or one of the ethylene copolymer rubbers such as ethylene-propylene rubber (EPR) or ethylene-propylene diene terpolymer (EPDM).

Current strippable insulation shield compositions are usually based on an ethylene-vinyl acetate (EVA) copolymer base resin rendered conductive with an appropriate type and amount of carbon black. The peel characterization of the strippable shield can be obtained by the proper selection of the EVA with a sufficient vinyl acetate content, usually about 32 to about 40 percent vinyl acetate, and usually with a nitrile rubber as an adhesion-adjusting additive.

Strippable shield formulations of EVA copolymers and nitrile rubbers have been described by Ongchin, U.S. Pat. No. 4,286,023 and U.S. Pat. No. 4,246,142; Burns et al. European Patent No. 0 420 271 B1; Kakizaki et al, U.S. Pat. No. 4,412,938; and Jansun, U.S. Pat. No. 4,226,823, each reference being herein incorporated by reference into this application.

A problem with these strippable shield formulations of EVA and nitrile rubber is that the EVAs needed for this formulation have a relatively high vinyl acetate content to achieve the desired adhesion level with the result that the formulations are more rubbery than is desired for high speed extrusion of a commercial electric cable.

Alternative adhesion-adjusting additives have also been proposed for use with EVA, for example, waxy aliphatic hydrocarbons (Watanabe et al. U.S. Pat. No. 4,933,107, herein incorporated by reference); low-molecular weight polyethylene (Burns Jr., U.S. Pat. No. 4,150,193 herein incorporated by reference); silicone oils, rubbers and block copolymers that are liquid at room temperature (Taniguchi et al. U.S. Pat. No. 4,493,787 herein incorporated by reference); chlorosulfonated polyethylene, ethylene-propylene rubbers, polychloroprene, styrene-butadiene rubber, natural rubber (all in Janssun) but the only one that appears to have found commercial acceptance was paraffin waxes.

U.S. Pat. No. 5,556,697 discloses that semiconductive conductor shields may be formed by dispersing certain selected carbon blacks in a linear, single-site catalyzed ethylene polymer, comprising (a) a linear, single-site catalyzed polymer comprising ethylene polymerized with at least one comonomer selected from the group consisting of C3 to C20 alpha-olefins, (b) a carbon black selected from the group consisting of (i) a furnace carbon black that contains ash in an amount of 50 ppm or less, sulfur in an amount of 50 ppm or less, and has crystal dimensions Lₐ and L_{c} of 30 Å or less, (ii) an acetylene carbon black, and (iii) a furnace carbon black having an ASTM grade of N-351, and (c) a crosslinking agent. Reportedly, semiconductive shields made of these compositions have significantly improved physical properties, such as low shrinkback, low water vapor transmission and smooth interfaces, better toughness, abrasion resistance, low temperature brittleness, low extractables and flexibility as well as better processability compared to known semiconductive shields. In addition, the semiconductive shield compositions do not abrade or corrode extrusion equipment and exhibit good compatibility with both copper and aluminum conductors. U.S. Pat. No. 8,388,868 discloses the semiconductive conductor shield composition of U.S. Pat. No. 5,556,697 further comprising low density polyethylene (LDPE), linear low density polyethylene (LLDPE), and mixtures thereof.

U.S. Pat. No. 6,013,202 discloses a class of adhesion-adjusting additive which allows shield compositions to be formulated, if desired, utilizing EVAs of lower vinyl acetate content for a given level of adhesion, and thus to make strippable shields that are less rubbery and thus easier to process than current formulations utilising nitrile rubbers. The adhesion-controlling additive is a copolymer of ethylene with a mono-unsaturated ester containing from 0.5 to 2 percent by weight of side-chains each of which comprises an inflexible ring structure bonded to a backbone carbon atom of the copolymer with at most five atoms interposed between them. As inflexible ring structures may be considered all rings of five or fewer members and six-membered aromatic rings, including (in both cases) condensed ring structures.

U.S. Pat. No. 6,402,993 discloses the use of ethylene vinyl acetate, ethylene alkyl acrylate, or ethylene alkyl methacrylate copolymer waxes with a molecular weight greater than 20,000 and a polydispersity greater than 2 as adhesion modifiers when used with a strippable semiconductive shield base resin, a suitable conductive carbon black, and a conventional insulation. The strippable semiconductive shield base resin can include ethylene vinyl acetate copolymers, ethylene alkyl acrylate copolymers wherein the alkyl group is selected from C1 to C6 hydrocarbons, ethylene alkyl methacrylate copolymers wherein the alkyl group is selected from C1 to C6 hydrocarbons, and ternary copolymers of ethylene with alkyl acrylates and alkyl methacrylates.

U.S. Pat. No. 5,036,140 discloses the use of a butene-1 copolymer with a certain comonomer having a content of from 1-30 mole percent in a heat sealable wrapping or packing film which is capable of forming a peelable seal. The film composition comprises a mixture containing an ethylenic polymer, the butene-1 polymer, and a propylene polymer. U.S. Publication No. 2012/0238704 discloses an improved balance of heat-sealability and optical properties by blending a major amount of specific propylene copolymers with a butene-1 polymer having low values of flexural modulus. The propylene copolymers were present in an amount from 70 to 95 percent with the butene-1 polymer present in an amount from 5 to 30 percent, having 75 weight percent or more, based upon the total weight of the butene-1 polymer, of butene-1 derived units, and having a flexural modulus of 60 MPa or less.

It continues to be desirable that semiconductive shields have improved physical properties, such as low shrinkback, low water vapor transmission and smooth interfaces, better toughness, abrasion resistance, low temperature brittleness, low extractables and flexibility as well as better processability compared to known semiconductive shields. In addition, it is also desirable that the semiconductive shield compositions do not abrade or corrode extrusion equipment and exhibit good compatibility with both copper and aluminum conductors. Moreover, it is desirable to provide semiconductive shields made with or containing lower mono-unsaturated ester content than produced with conventional ethylene/mono-unsaturated ester copolymer-based semiconductive shield compositions. Furthermore, it is desirable to include or substitute a component in semiconductive shield compositions that facilitates modification of adhesion of presently-available semiconductive shields.

### SUMMARY OF THE INVENTION

In general embodiments, the present disclosure provides an insulated electrical cable having: (a) an electrically conductive core; and (b) a semiconductive shield containing a composition made from and/or containing a butene-1 polymer composition, an ethylene copolymer, and a conductive carbon black composition. The semiconductive shield is formed over the electrically conductive core.

In some embodiments, the present disclosure provides an insulated electrical cable having: (a) an electrically conductive core; and (b) a semiconductive shield containing a semiconductive shield composition made from and/or containing (i) a butene-1 polymer composition comprising a butene-1 polymer having at least about 75 weight percent, based upon the total weight of the butene-1 polymer, of butene-1 derived units and having a flexural modulus of at most 60 MPa, (ii) an ethylene copolymer, and (iii) a conductive carbon black composition which is present in an amount sufficient to give the semiconductive shield a resistance below about 550 ohm-meter.

Moreover, the present disclosure provides a method of manufacturing an insulated electrical cable including the steps of (a) extruding a semiconductive shield over an electrically conductive core from a semiconductive shield composition, (b) extruding an insulation layer over the semiconductive shield, and optionally, (c) extruding a semiconductive layer over the insulation layer. Furthermore, the present disclosure provides a method for manufacturing medium voltage electric power cables.

### DESCRIPTION OF THE DRAWINGS

Further details will be apparent from the following detailed description, with reference to the enclosed drawings, in which:

FIG. 1 is a cross-sectional view of a typical medium voltage power cable.

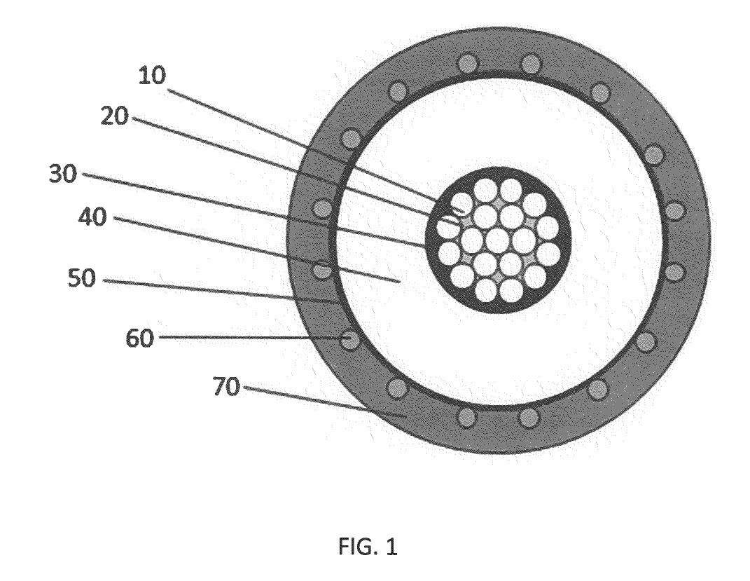

FIG. 2 is a set of Transmission Electron Microscopy (TEM) pictures of films made from and/or containing blends of a polyethylene and a butene-1 polymer.

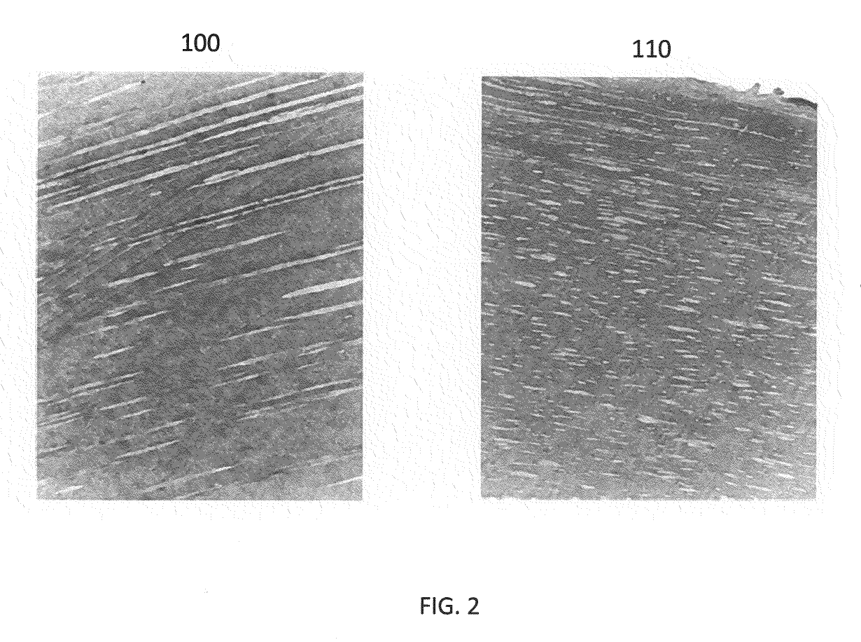

### DETAILED DESCRIPTION

The present invention now will be described more fully hereinafter. However, this invention may be embodied in many different forms and should not be construed as limited to the embodiments set forth herein; rather, these embodiments are provided so that this disclosure will satisfy applicable legal requirements. As used in this specification and the claims, the singular forms “a,” “an,” and “the” include plural referents unless the context clearly dictates otherwise.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

### DEFINITIONS

In the present description, the term “α-olefin” means an olefin of formula CH₂═CH—R, wherein R is a linear or branched alkyl containing from 1 to 10 carbon atoms. The α-olefin can be selected, for example, from: propylene, 1-butene, 1-pentene, 1-hexene, 1-octene, 1-dodecene and the like.

In the present description, the term “butene-1 polymer” as used herein refers to butene-1 homopolymers, copolymers, and mixtures thereof; having from elastomeric to plastomeric behaviour and generically also referred to as “plastomers.” Preferred α-olefins which may be present as comonomers in the butene-1 polymer are ethylene, propylene, pentene-1, hexene-1,4-methyl-1-pentene, and octene-1. Particularly preferred as comonomers are propylene and ethylene.

In the present description, the term “composition distribution” refers to the distribution of comonomer between polymer molecules and is directly related to crystallizability, hexane extractability, toughness, and filler acceptance.

In the present description, the term “extra high voltage cables” refers to power cables having a voltage of greater than about 232 kV.

In the present description, the term “high voltage cables” refers to power cables having a voltage of from about 115 kV to about 230 kV.

In the present description, the term “medium voltage cables” refers to power cables having a voltage of from about 0.60 kV to about 69 kV.

In the present description, the term “polyethylene” is meant to include both homopolymers and copolymers wherein ethylene is the sole monomer or the major comonomer.

### Testing

Comonomer content: Ethylene and 1-butene content of the polymers by I.R. spectroscopy.

Flexural modulus is measured according to ISO 178. The term “ISO 178” as used herein refers to the standard test method for testing the flexural properties of a material. In particular, the flexural test measures the force required to bend a beam under three point loading conditions. The data is often used to select materials for parts that will support loads without flexing. Flexural modulus is used as an indication of a material's stiffness when flexed. Since the physical properties of many materials (especially thermoplastics) can vary depending on ambient temperature, it is sometimes appropriate to test materials at temperatures that simulate the intended end use environment. Most commonly the specimen lies on a support span and the load is applied to the center by the loading nose producing three point bending at a specified rate. The parameters for this test are the support span, the speed of the loading, and the maximum deflection for the test. These parameters are based on the test specimen thickness and are defined differently by ASTM and ISO standards. For ASTM D790, the test is stopped when the specimen reaches 5% deflection or the specimen breaks before 5%. For ISO 178, the test is stopped when the specimen breaks. Of the specimen does not break, the test is continued as far as possible and the stress at 3.5% (conventional deflection) is reported. A variety of specimen shapes can be used for this test, but the most commonly used specimen size for ASTM is 3.2 mm×12.7 mm×125 mm (0.125″×0.5″×5.0″) and for ISO is 10 mm×4 mm×80 mm. By using the flexural text, the following data may be obtained: flexural stress at yield, flexural strain at yield, flexural stress at break, flexural strain at break, flexural stress at 3.5% (ISO) or 5.0% (ASTM) deflection, and flexural modulus.

Intrinsic viscosity [η]: Measured in tetraline at 135 degrees Celsius.

Melt Flow Rate (MFR): The term “ISO 1133-1” as used herein refers to the standard test method for determining the melt mass-flow rate (MFR) and the melt volume-flow rate (MVR) of thermoplastic materials under specified conditions of temperature and load. Two procedures include a mass-measurement method and a displacement-measurement method. The MVR is particularly useful when comparing materials of different filler content and when comparing filled with unfilled thermoplastics. The MFR can be determined from MVR measurements, or vice versa, provided the melt density at the test temperature is known. The melt mass-flow rate (MFR) and the melt volume-flow rate (MVR) are determined by extruding molten material from the cylinder of a plastometer through a die of specified length and diameter under preset conditions of temperature and load. For measurement of MFR, timed segments of the extrudate are weighed and used to calculate the extrusion rate, in grams per 10 min. For measurement of MVR, the distance that the piston moves in a specified time or the time required for the piston to move a specified distance is recorded and used to calculate the extrusion rate in cubic centimeters per 10 min. Measured according to ISO 1133-1 at 190 degrees Celsius with 2.16 kg load for butene-1 polymers.

MWD and M_{w}/Mₙ (Polydispersity) Determination: MWD and the ratio M_{w}/Mₙ are determined using a Waters 150-C ALC/Gel Permeation Chromatography (GPC) system equipped with a TSK column set (type GMHXL-HT) working at 135 degrees Celsius with 1,2-dichlorobenzene as solvent (ODCB) (stabilized with 0.1 vol. of 2,6-di-t-butyl p-cresole (BHT)) at flow rate of 1 ml/min. The sample is dissolved in ODCB by stirring continuously at a temperature of 140 degrees Celsius for 1 hour. The solution is filtered through a 0.45 μm Teflon membrane. The filtrate (concentration 0.08-1.2 g/l injection volume 300 μl) is subjected to GPC. Monodisperse fractions of polystyrene (provided by Polymer Laboratories) are used as standard. The universal calibration for butene-1 polymers is performed by using a linear combination of the Mark-Houwink constants for PS (K=7.11×10-5 dl/g; a=0.743) and PB(K=1.18×10-4 dl/g; a=0.725).

Shore A Hardness: The shore A hardness is measured according to ISO868. The term “ISO 868” as used herein refers to the standard test method for determining the indentation hardness of plastics and ebonite by means of durometers of two types: type A is used for softer materials and type D for harder materials. The method permits measurement either of the initial indentation or of the indentation after a specified period of time, or both. A specified indenter is forced into the test material under specified conditions and the depth of penetration measured. The indentation hardness is inversely related to the penetration and is dependent on the modulus of elasticity and the viscoelastic properties of the material. The shape of the indenter, the force applied to it and the duration of its application influence the results obtained so that there may be no simple relationship between the results obtained with one type of durometer and those obtained with either another type of durometer or another instrument for measuring hardness. The thickness of the test specimen shall be at least 4 mm. The dimensions of the test specimen shall be sufficient to permit measurements at least 9 mm away from any edge, unless it is known that identical results are obtained when measurements are made at a lesser distance from an edge. The surface of the test specimen shall be flat over an area sufficient to permit the presser foot to be in contact with the test specimen over an area having a radius of at least 6 mm from the indenter point.

T-Peel: The materials are admixed at temperatures below 140 degrees Celsius for a mix cycle of seven (7) minutes. Next, the mixtures are pelletized. Subsequently, the pellets are extruded at about 138 degrees Celsius (280 degrees Farenheit) to make 7-mil thick tapes on a cast line. The tapes are cut into 1.0 inch wide×3-4 inch long strips and sealed at a temperature of greater than about 140 degrees Celsius to the substrates for comparison. Exemplary substrates include (a) LDPE tapes, (b) aluminum tapes, and (c) copper tapes.

An end is lifted and turned back 180° to lie along the surface of the portion still adhered, and the force required to peel at a rate of 0:0085 m/s (20 in/min) is measured. Peel strength is calculated in N/15 mm and pounds per ½ inch. For strippable shield applications, the peel strength is preferably between about 3 to about 26 pounds per ½ inch.

X-ray crystallinity: The X-ray crystallinity is measured with an X-ray Diffraction Powder Diffractometer using the Cu-Kα1 radiation with fixed slits and collecting spectra between diffraction angle 20=5° and 20=35° with step of 0.10 every 6 seconds. Measurements are performed on compression molded specimens in the form of disks of about 1.5 to about 2.5 mm of thickness and about 2.5 to about 4.0 cm of diameter. These specimens are obtained in a compression molding press at a temperature of about 200 degrees Celsius±5 degrees Celsius without any appreciable applied pressure for 10 minutes, then applying a pressure of about 10 kg/cm² for about few second and repeating this last operation for 3 times. The diffraction pattern is used to derive all the components necessary for the degree of crystallinity by defining a suitable linear baseline for the whole spectrum and calculating the total area (Ta), expressed in counts/sec·2Θ, between the spectrum profile and the baseline. Then a suitable amorphous profile is defined, along the whole spectrum, that separate, according to the two-phase model, the amorphous regions from the crystalline ones. Thus it is possible to calculate the amorphous area (Aa), expressed in counts/sec·2Θ, as the area between the amorphous profile and the baseline; and the crystalline area (Ca), expressed in counts/sec·2Θ, as Ca=Ta−Aa. The degree of crystallinity of the sample is then calculated according to the formula:

percent Cr=100×Ca/Ta

Xylene Solubles for Butene-1 Polymers (percent by weight): 2.5 g of polymer are dissolved in 250 ml of xylene, at 135 degrees Celsius, under agitation. After 20 minutes, the solution is cooled to 0 degrees Celsius under stirring, and then it is allowed to settle for 30 minutes. The precipitate is filtered with filter paper; the solution is evaporated under a nitrogen current, and the residue dried under vacuum at 140 degrees Celsius until constant weight. The weight percentage of polymer soluble in xylene at 0 degrees Celsius is then calculated. The percent by weight of polymer insoluble in xylene at room temperature is considered the isotactic index of the polymer.

Thermal Properties Definition

The thermal properties (melting temperatures and entalpies) are determined by Differential Scanning Calorimetry (DSC) on a Perkin Elmer DSC-7 instrument according to ISO 11357, Part 3.

The melting temperatures of butene-1 polymers are determined according to the following detailed method. A weighed sample (5-10 mg) obtained from the polymerization is sealed into aluminum pans and heated at 200 degrees Celsius with a scanning speed corresponding to 20 degrees Celsius/minute. The sample is kept at 200 degrees Celsius for 5 minutes to allow a complete melting of all the crystallites. Successively, after cooling to −20 degrees Celsius with a scanning speed corresponding to 10 degrees Celsius/minute, the peak temperature is taken as crystallization temperature (Tc). After standing 5 minutes at −20 degrees Celsius, the sample is heated for the second time at 200 degrees Celsius with a scanning speed corresponding to 10 degrees Celsius/min. In this second heating run, the first peak temperature found starting from the low-temperature side is taken as the melting temperature (TmII) and the area as melting enthalpy (ΔHfII) of the crystalline form II, when present, that is also the global melting enthalpy in this measurement condition.

TmI (melting temperature of crystalline form I) is the second peak temperature found in a DSC thermogram starting from the low-temperature side after TmII (melting temperature peak of the crystalline form II). TmI is measured, when present, after storing the sample at room temperature for 10 days to allow stabilization of the cristalline form I and II. When a butene-1 polymer is produced, it usually crystallizes from its solution in the tetragonal form II which then spontaneously transforms into the thermodynamically stable, trigonal form I, as reported in J. Appl. Phys. 1964, 35, 3241 and Macromolecules 1998, 31.

TmII (Measured in Second Heating Run).

The melting enthalpy after 10 days of butene-1 polymers is determined according to the following detailed method: a weighed sample (5-10 mg) obtained from the polymerization is sealed into aluminum pans and heated at 200 degrees Celsius with a scanning speed corresponding to 20 degrees Celsius/minute. The sample is kept at 200 degrees Celsius for 5 minutes to allow a complete melting of all the crystallites. The sample is then stored for 10 days at room temperature. After 10 days, the sample is analyzed by DSC in which the sample is cooled to −20 degrees Celsius, and then it is gradually heated to 200 degrees Celsius with a scanning speed corresponding to 10 degrees Celsius/min. In this heating run, the first peak temperature found starting from the low-temperature side is taken as the melting temperature (Tm substantially equal to TmI) and the area as global melting enthalpy after 10 days (ΔHf).

ΔHf is measured when the TmII (in second heating run) is not detectable (nd), and it is considered diagnostic of a low crystallinity.

In a particular embodiment, the present disclosure provides an insulated electrical cable having (a) an electrically conductive core and (b) a semiconductive shield formed over the electrically conductive core from a semiconductive shield composition made from and/or containing (i) a butene-1 polymer composition comprising a butene-1 polymer having at least about 75 weight percent, based upon the total weight of the butene-1 polymer, of butene-1 derived units and having a flexural modulus of at most 60 MPa, (ii) an ethylene copolymer, and (iii) a conductive carbon black composition in an amount sufficient to give the semiconductive shield a resistance below about 550 ohm-meter.

The insulated electrical cables can be electrical wires and power cables. Preferably, they are medium voltage power cables, high voltage power cables, or extra high voltage power cables. More preferably, they are medium voltage power cables.

The electrically conductive core includes any metallic conductor known in the art for conveying medium voltage power. Suitable examples include aluminum and copper conductors.

The butene-1 polymer of the semiconductive shield composition has at least about 75 weight percent, based upon the total weight of the butene-1 polymer, of butene-1 derived units and has a flexural modulus of at most 60 MPa. The butene-polymer can be any of butene-1 homopolymers, copolymers, and mixtures thereof. It can have elastomeric to plastomeric behaviour. When the butene-1 polymer is a copolymer, the preferred comonomers are ethylene, propylene, pentene-1, hexene-1,4-methyl-1-pentene, and octene-1. More preferred, comonomers are propylene and ethylene. Most preferably, the comonomer is propylene.

Preferably, when the comonomer is ethylene, the copolymer will have an ethylene comonomer content of about 1 to about 15 mole percent. Also, preferably, when the comonomer is a propylene, the copolymer will have a propylene comonomer content of about 5 to about 30 mole percent. Also, preferably, when the comonomer is an alpha-olefin having 5-8 carbon atoms, the copolymer will have an alpha-olefin comonomer content of about 5 to about 30 mole percent.

With regard to the content of butene-1 derived units in the butene-1 polymer, it is preferable that the butene-1 polymer have at least about 80 weight percent, based upon the total weight of the butene-1 polymer, of butene-1 derived units, more preferably at least about 84 weight percent, and even more preferably at least about 90 weight percent.

With regard to the flexural modulus of the butene-1 polymer, it is preferable that the flexural modulus be at most about 40 MPa, more preferably at most about 30 MPa.

With regard to shore A hardness of the butene-1 polymer, it is preferably equal to or less than about 90 points.

With regard to crystallinity of the butene-1 polymer, it preferably exhibits low crystallinity (less than about 40 percent measured via X-ray, more preferably, less than about 35 percent).

The butene-1 polymer composition is preferably made from and/or contains a butene-1 polymer selected from following polymers a first butene-1 polymer (B1), a second butene-1 polymer (B2), and a third butene-1 polymer (B3).

The first butene-1 polymer (B1) is a butene-1 homopolymer or copolymer of butene-1 with at least one α-olefin. Preferably, the α-olefin is propylene as comonomer. Also, preferably the first butene-1 polymer (B1) will have a percentage of isotactic pentads from about 25 to about 55 percent. Optionally, the first butene-1 polymer (B1) will have at least one of the following properties: (a) intrinsic viscosity [θ] measured in tetraline at 135 degrees Celsius from about 0.6 to about 3 dL/g and (b) amount of xylene insoluble fraction at 0 degrees Celius from about 3 to about 60 weight percent.

The second butene-1 polymer (B2) is a butene-1/ethylene copolymer having a percentage of isotactic pentads equal to or higher than about 96 percent, and a total content of ethylene units in the range of about 10 to about 25 mol percent corresponding to about 5 to about 15 weight percent. The second butene-1 polymer (B2) can be advantageously a composition consisting of (i) a first copolymer having less than about 10 mol percent, based upon the total weight of the first copolymer, of ethylene derived units, preferably from about 1 to about 9 mol percent, and (ii) a second copolymer having higher than about 10 mol percent, based upon the total weight of the second copolymer, of ethylene derived units; the resulting total content of ethylene derived units is in the range of about 10 to about 25 mol percent, based upon the total weight of the second butene-1 polymer, as described in the first sentence of this paragraph. The highly modified component (second copolymer (ii)) has typically an elastomeric behaviour and the second butene-1 polymer (B2) can be consequently an heterophasic composition.

The third butene-1 polymer (B3) is a butene-1 polymer having a distribution of molecular weights (Mw/Mn) measured by GPC lower than 3 and at least one of the following properties: (a) no melting point (TmII) that is detectable in the DSC thermogram, as measured according to the DSC method described herein and (b) a measurable melting enthalpy (ΔHf) after aging. Particularly, the melting enthalpy of the third butene-1 polymer (B3) measured after 10 days of aging at room temperature, when present, is of less than about 25 J/g, preferably from about 4 to about 20 J/g.

The first butene-1 polymer (B1) and the second butene-1 polymer (B2) can be prepared by polymerization of the monomers in the presence of a low stereospecificity Ziegler-Natta catalyst comprising (a) a solid component comprising a Ti compound and an internal electron-donor compound supported on MgCl₂; (b) an alkylaluminum compound and, optionally, (c) an external electron-donor compound. In a preferred aspect of the process for the preparation of the first butene-1 polymer (B1), the external electron donor compound is not used in order not to increase the stereoregulating capability of the catalyst. In cases in which the external donor is used, its amount and modalities of use should be such as not to generate a too high amount of highly stereoregular polymer, as described in PCT Publication No. WO 2006/042815. The butene-1 polymers thus obtained typically have a content of isotactic pentads from about 25 to about 55 percent. The second butene-1 polymer (B2) can be prepared by polymerization of the monomers in the presence of a stereospecific Ziegler Natta catalyst wherein the external electron donor compound (c) is chosen and used in amounts according to the process described in PCT Publication No. WO 2004/048424.

The polymerization process for the first butene-1 polymer (B1) and the second butene-1 polymer (B2) can be carried out according to known techniques. Suitable examples include slurry polymerization using as diluent a liquid inert hydrocarbon and solution polymerization using liquid butene-1 as a reaction medium. Moreover, it may also be possible to carry out the polymerization process in the gas-phase, operating in one or more fluidized or mechanically agitated bed reactors. The polymerization carried out in the liquid butene-1 as a reaction medium is highly preferred. The polymerization is generally carried out at temperature of from about 20 degrees Celsius to about 120 degrees Celsius and preferably of from about 40 degrees Celsius to about 90 degrees Celsius. The polymerization can be carried out in one or more reactors that can work under same or different reaction conditions such as concentration of molecular weight regulator, comonomer concentration, external electron donor concentration, temperature, pressure, etc.

The third butene-1 polymer (B3) can be a butene-1/ethylene copolymer or a butene-1/ethylene/propylene copolymer obtained by contacting under polymerization conditions, butene-1 and ethylene and optionally propylene in the presence of a metallocene catalyst system obtainable by contacting (a) a stereorigid metallocene compound, (b) an alumoxane or a compound capable of forming an alkyl metallocene cation, and optionally, (c) an organo aluminum compound. Examples of such third butene-1 metallocene copolymers (B3), catalyst and process can be found in PCT Publication No. WO 2004/099269 and PCT Publication No. WO 2009/000637.

The process for the polymerization of the third butene-1 polymer (B3) can be carried out in the liquid phase in the presence or absence of an inert hydrocarbon solvent, such as in slurry, or in the gas phase. The hydrocarbon solvent can either be aromatic such as toluene, or aliphatic such as propane, hexane, heptane, isobutane or cyclohexane. Preferably, the third butene-1 polymers (B3) are obtained by a solution process, i.e. a process carried out in liquid phase wherein the polymer is completely or partially soluble in the reaction medium. As a general rule, the polymerization temperature is generally comprised between about −100 degrees Celsius and about +200 degrees Celsius, preferably comprised between about 40 degrees Celsius and about 90 degrees Celsius, and more preferably between about 50 degrees Celsius and about 80 degrees Celsius. The polymerization pressure is generally comprised between about 0.5 bar and about 100 bar.

The lower the polymerization temperature, the higher are the resulting molecular weights of the polymers obtained.

The third butene-1 polymer (B3) can be advantageously also a composition consisting of (i) a first polymer composition comprising about 80 weight percent or more, based upon the total weight of the butene-1 polymer composition, of butene-1 polymers having the properties of the third butene-1 polymer (B3) and (ii) a second polymer composition comprising up to about 20 weight percent of a crystalline propylene polymer, based upon the total weight of the butene-1 polymer composition. The total content of ethylene and/or propylene derived units in the composition (i)+(ii) are present in amounts equal to or less than about 25 weight percent, based upon the total weight of the butene-1 polymer composition.

The crystalline propylene polymer has typically a value of melt flow rate (MFR) of from about 2 to about 10 g/10 min at 230 degrees Celsius and a weight of 2.16 kg, and a melting temperature of from about 130 degrees Celsius to about 160 degrees Celsius as determined through analysis of a DSC thermogram.

The overall handability of the first polymer composition (i) can be advantageously improved by in line compounding up to about 20 weight percent of the second polymer composition (ii), based upon the total weight of the buten-1 polymer composition, without substantial deterioration of other mechanical properties.

The butene-1 polymer composition is preferably present in the semiconductive shield composition in an amount of from about 0.5 weight percent to about 10 weight percent of the total formulation, more preferably from about 1.0 weight percent to about 5.0 weight percent.

The ethylene copolymer composition is preferably a composition made from and/or containing a linear, single-site catalyzed polymer made from and/or containing ethylene polymerized with at least one comonomer selected from the group consisting of C3 to C20 alpha-olefins. Useful linear, single-site (also called metallocene) catalyzed ethylene polymers are disclosed in U.S. Pat. No. 5,246,783, the entire disclosure of which is incorporated herein by reference. Linear, single-site catalyzed polymers are commercially available and require no special modification to be useful in practicing the present invention.

When the ethylene copolymer composition is made from and/or contains a linear, single-site catalyzed polymer, the resulting semiconductive shield can be used as a conductor shield or an insulation shield; however, it is preferentially used as a conductor shield.

Examples of useful polymers include linear, single-site catalyzed ethylene/butene-1 copolymers, ethylene/propylene copolymers, ethylene/hexene-1 copolymers, ethylene/octene-1 copolymers, ethylene/propylene/1,4-hexadiene terpolymers, and ethylene/buten-1/1,4-hexadiene terpolymers. Ethylene/butene copolymers, ethylene/propylene copolymers, ethylene/octene copolymers, and ethylene/hexene copolymers are most preferred. The higher alpha-olefins tend to provide improved physical properties.

The linear, single-site catalyzed polymer preferably has a density of about 0.9 g/cm³, although polymers having a broad range of densities may be used depending on cost restraints. The polymer preferably has a weight average molecular weight of from about 30,000 to about 70,000. Most preferably, the polymer has a weight average molecular weight of about 42,500, a number average molecular weight of about 20,000, and a Z average molecular weight of about 66,700. The polymer preferably has a polydispersity of from about 1.8 to about 5, more preferably, about 2 to about 3, even more preferably, about 2 to about 2.5, and most preferably about 2.15.

The selected single-site catalyzed resins have a narrow compositional distribution, i.e., all the polymer molecules (chains) tend to have the same comonomer content throughout the entire resin sample regardless of the molecular weight of the chain.

The ethylene copolymer composition is preferably present in the semiconductive shield composition in an amount of from about 50 to about 80 weight percent of the total formulation, more preferably about 55 to about 75 weight percent.

When the ethylene copolymer composition is made from and/or contains a linear, single-site catalyzed polymer made from and/or containing ethylene polymerized with at least one comonomer selected from the group consisting of C3 to C20 alpha-olefins, the semiconductive shield composition may further be made from and/or contain LDPE, LLDPE, or VLDPE, which component is different from the ethylene copolymer. Preferably, the LDPE, LLDPE or VLDPE polymers will have a density of about 0.90 and a melt index of between about 10 and about 50. Even more preferably, the ethylene copolymer and the LDPE, LLDPE or VLDPE polymer have roughly similar melt index. Most preferably, the optional polymer will be LDPE.

A polar ethylene copolymer may be further mixed with the LDPE. Selection of the polar ethylene copolymer should be such as to avoid phase separation from the LDPE. The polar ethylene copolymer should preferably have no more than about 20 percent comonomer content, and the LDPE should have a melt index at least about 50 percent greater than the polar ethylene copolymer. An example of a suitable polar ethylene copolymer is an ethylene vinyl-silane copolymer.

When present, the optional polymer may be present in any amount from about 5 to about 50 weight percent of the ethylene copolymer composition.

Like the linear, single-site catalyzed polymer described previously, the ethylene copolymer composition preferably is made from and/or contains a base resin selected from any suitable member of the group consisting of (a) ethylene vinyl acetate copolymers, (b) ethylene alkyl acrylate copolymers wherein the alkyl group is selected from C1 to C6 hydrocarbons, (c) ethylene alkyl methacrylate copolymers wherein the alkyl group is selected from C1 to C6 hydrocarbons, and (d) ethylene alkyl acrylate alkyl methacrylate terpolymers wherein the alkyl group is independently selected from C1 to C6 hydrocarbons.

When the ethylene copolymer composition is made from and/or contains one of these polymers, the semiconductive shield composition should further be made from and/or contain an adhesion-modifying compound different from the base polymer. The adhesion-modifying compound is selected from the group consisting of (i) ethylene vinyl acetate copolymers, (ii) ethylene alkyl acrylate copolymers wherein the alkyl group is selected from C1 to C6 hydrocarbons, and (iii) ethylene alkyl methacrylate copolymers wherein the alkyl group is selected from C1 to C6 hydrocarbons, with the adhesion-modifying compound having a molecular weight greater than about 20,000 daltons and a polydispersity greater than about 2.5.

When the ethylene copolymer composition is made from and/or contains a base resin selected from any suitable member of the group consisting of (a) ethylene vinyl acetate copolymers, (b) ethylene alkyl acrylate copolymers wherein the alkyl group is selected from C1 to C6 hydrocarbons, (c) ethylene alkyl metbacrylate copolymers wherein the alkyl group is selected from C1 to C6 hydrocarbons, and (d) ethylene alkyl acrylate alkyl methacrylate terpolymers wherein the alkyl group is independently selected from C1 to C6 hydrocarbons, the resulting semiconductive shield can be used as a conductor shield or an insulation shield. It is preferentially used as an insulation shield.

The ethylene vinyl acetate copolymer base resin can be any EVA copolymer with the following properties: the ability to accept high loadings of conductive carbon filler, elongation of about 150 to about 250 percent, and sufficient melt strength to maintain its shape after extrusion. EVA copolymers with vinyl acetate levels above about 25 percent and below about 45 percent having these properties are known. The EVA copolymers can have a vinyl acetate percentage range of about 25 to about 45 percent. A preferred EVA copolymer will have a vinyl acetate percentage range of about 28 to about 40 percent, and an even more preferred EVA copolymer will have a vinyl acetate percentage of about 28 to about 33 percent. The EVA copolymers can have a molecular weight from about 40,000 to about 150,000 daltons, preferably about 45,000 to about 100,000 daltons, and even more preferably about 50,000 to about 75,000 daltons. Examples of suitable EVA copolymers would include Elvax™ 150, Elvax™ 240 and Elvax™ 350, sold by DuPont Corp. of Wilmington Del.

The ethylene alkyl acrylate copolymers can be any suitable ethylene alkyl acrylate copolymers with the following properties: the ability to accept high loadings of conductive carbon filler, elongation of about 150 to about 250 percent, and sufficient melt strength to maintain its shape after extrusion. The alkyl group can be any alkyl group selected from the C1 to C6 hydrocarbons, preferably the C1 to C4 hydrocarbons, and even more preferable methyl. Some ethylene alkyl acrylate copolymers with alkyl acrylate levels above about 25 percent and below about 45 percent have these properties. The ethylene alkyl acrylate copolymers can have an alkyl acrylate percentage range of about 25 to about 45 percent. A preferred ethylene alkyl acrylate copolymer will have an alkyl acrylate percentage range of about 28 to about 40 percent, and an even more preferred ethylene alkyl acrylate copolymer will have an alkyl acrylate percentage of about 28 to about 33 percent. The ethylene alkyl acrylate copolymers can have a molecular weight from about 40,000 to about 150,000 daltons, preferably about 45,000 to about 100,000 daltons, and even more preferably about 50,000 to about 75,000 daltons. Examples of suitable ethylene alkyl acrylate copolymers include Vamac™ G or Vamac™ HG sold by DuPont Corp. of Wilmington, Del.

The ethylene alkyl methacrylate copolymers can be any suitable ethylene alkyl methacrylate copolymer with the following properties: the ability to accept high loadings of conductive carbon filler, elongation of about 150 to about 250 percent, and sufficient melt strength to maintain its shape after extrusion. The alkyl group can be any alkyl group selected from the C1 to C6 hydrocarbons, preferably the C1 to C4 hydrocarbons, and even more preferable methyl. Some ethylene alkyl methacrylate copolymers with alkyl methacrylate levels above about 25 percent and below about 45 percent have these properties. The ethylene alkyl methacrylate copolymers can have an alkyl methacrylate percentage range of about 25 to 45 percent. A preferred ethylene alkyl methacrylate copolymer will have an alkyl methacrylate percentage range of about 28 to about 40 percent, and an even more preferred ethylene alkyl methacrylate copolymer will have an alkyl methacrylate percentage of about 28 to about 33 percent. The ethylene alkyl methacrylate copolymers can have a molecular weight from about 40,000 to about 150,000 daltons preferably about 45,000 to about 100,000 daltons and even more preferably about 50,000 to about 75,000 daltons. An example of a commercially available ethylene methyl methacrylate is 35MA05 from Atofina of Paris La Defence, France.

The ethylene alkyl acrylate alkyl methacrylate terpolymer can be any suitable ternary copolymer with the following properties: the ability to accept high loadings of conductive carbon filler, elongation of about 150 to about 250 percent, and sufficient melt strength to maintain its shape after extrusion. The alkyl group can be any alkyl group independently selected from the C1 to C6 hydrocarbons, preferably the C1 to C4 hydrocarbons and even more preferable methyl. Usually a ternary copolymer will be predominantly either an alkyl acrylate with a small portion of an alkyl methacrylate or an alkyl methacrylate with a small portion of an alkyl acrylate. The proportions of alkyl acrylate and alkyl methacrylate to ethylene will be about the same as the proportions described for ethylene alkyl acrylate copolymers or for ethylene alkyl methacrylate copolymers as well as the molecular weight ranges described for ethylene alkyl acrylate and ethylene alkyl methacrylate.

The adhesion modifying compounds are any suitable ethylene vinyl acetate copolymer, ethylene alkyl acrylate copolymer, or ethylene alkyl methacrylate copolymer, with a molecular weight greater than about 20,000 daltons, preferably from about 22,500 to about 50,000 daltons, and even more preferably from about 25,000 to about 40,000 daltons. The adhesion modifying copolymers will have a polydispersivity greater than about 2.5, preferably a polydispersivity greater than about 4, and even more preferably, a polydispersivity greater than about 5. The proportion of non-ethylene comonomer (vinyl acetate, alkyl acrylate, or alkyl methacrylate) in the adhesion modifying copolymers should be about 10 to about 28 percent, preferably about 12 to about 25, and even more preferably about 12 to about 20 percent. The alkyl group is selected from the C1 to C6 hydrocarbons, preferably the C1 to C4 hydrocarbons, and even more preferably methyl.

Suitable commercially EVA copolymer includes AC 415, a 15 percent vinyl acetate wax available from Honeywell Inc. of Morristown, N.J.

The proportion of the adhesion modifying compound to the other compounds in the semiconductive shield will vary depending on the base polymer, underlying insulation, molecular weight of the adhesion modifying compound, and polydispersity of the adhesion modifying compound. Preferably, the adhesion modifying compound will be added in amount between about 0.5 to about 10 weight percent, more preferably, between about 1.0 weight percent to about 7.5 weight percent, and even more preferably, between about 2.0 weight percent to about 7.0 weight percent.

The ethylene copolymer composition is preferably present in the semiconductive shield composition in an amount of from about 50 to about 80 weight percent of the total formulation, more preferably about 55 to about 75 weight percent.

The conductive carbon black composition can be made from and/or contain any conductive carbon blacks, which is present in an amount sufficient to decrease the electrical resistivity to less than 550 ohm-meter. Preferably, the resistivity of the semiconductive shield is less than about 250 ohm-meter and even more preferably, less than about 100 ohm-meter.

The carbon black composition is generally present in the composition in the amount of from about 0.1 percent to about 65 percent by weight of the polymer composition. Preferably, the carbon black composition is present in an amount of from about 10 percent to about 50 percent by weight, based on the weight of the total composition, more preferably, in an amount of from about 30 to about 45 weight percent.

The carbon black composition can made from and/or contain be one of the various commercially available conventional carbon blacks, including finely divided carbon such as lamp black, furnace black, or acetylene black, i.e. carbon black made by pyrolyzing acetylene. Preferably, to avoid problems associated with carbon black dust, the carbon black composition is pelletized although a non-pelletized carbon black composition, such as in its fluffy form, may also be used with equal success.

Preferred carbon black compositions are made from and/or contain (1) furnace carbon blacks that contain ash in an amount of about 50 ppm or less, sulfur in an amount of about 50 ppm or less, and have crystal dimensions Lₐ and L_{c} of about 30 Å or less, (2) acetylene carbon blacks, (3) furnace carbon blacks having an ASTM grade of N-351, and (4) furnace carbon blacks having an ASTM grade of N-550. More preferably, the carbon black composition will be made from and/or contain carbon black having a particle size from about 15 nm to about 22 nm, an Iodine number of from about 115 mg/g to about 200 mg/g, and a DBP number of from about 90 cm³/100 g to about 170 cm³/100 g.

When the ethylene copolymer is a linear, single-site catalyzed polymer made from and/or containing ethylene polymerized with at least one comonomer selected from the group consisting of C3 to C20 alpha-olefins, the carbon black composition is more preferably made from and/or contains (1) furnace carbon blacks that contain ash in an amount of about 50 ppm or less, sulfur in an amount of about 50 ppm or less, and have crystal dimensions Lₐ and L_{c} of about 30 Å or less, (2) acetylene carbon blacks, or (3) furnace carbon blacks having an ASTM grade of N-351. Even more preferably, the carbon black composition is made from and/or contains a carbon black having a particle size from about 15 nm to about 22 nm, an Iodine number of from about 115 mg/g to about 200 mg/g, and a DBP number of from about 90 cm³/100 g to about 170 cm³/100 g.

The compositions of the present invention can also contain additives commonly employed in the art, such as antioxidants, light stabilizers, heat stabilizers, colorants, fillers, coagents, crosslinking agents, processing aids, boosters and retardants, coupling agents, ultraviolet absorbers, antistatic agents, nucleating agents, slip agents, plasticizers, lubricants, viscosity control agents, tackifiers, anti-blocking agents, surfactants, extender oils, acid scavengers, and metal deactivators.

Non-limiting examples of antioxidants are octadecyl 3,5-di-tert-butyl-4-hydroxyhydrocinnamate, hindered phenols, phosphites, phosphonites, thio compounds such as dilaurylthiodipropionate, dimyristylthiodipropionate, and distearylthiodipropionate; various siloxanes; polymerized 2,2,4-trimethyl-1,2-dihydroquinoline (TMQ), n,n′-bis(1,4-dimethylpentyl-p-phenylenediamine), alkylated diphenylamines, 4,4′-bis(alpha,alpha-demthylbenzyl)diphenylamine, diphenyl-p-phenylenediamine, mixed di-aryl-p-phenylenediamines, and other hindered amine antidegradants or stabilizers. Antioxidants can be used in amounts of about 0.1 to about 5 percent by weight based on the weight of the composition.

Suitable hindered phenols include tetrakis[methylene(3,5-di-tert-butyl-4-hydroxyhydro-cinnamate)]methane, bis[(beta-(3,5-ditert-butyl-4-hydroxybenzyl)-methylcarboxyethyl)]sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)hydrocinnamate. Suitable phosphites and phosphonites include tris(2,4-di-tert-butylphenyl)phosphite and di-tert-butylphenyl-phosphonite.

Suitable processing aids include metal stearates or salts, polysiloxanes, and/or polyethylene glycols (molecular weights of from about 10,000 to about 30,000). Processing aids, when present, are generally used in amounts of from about 0.1 to about 5.0 weight percent, based on the total weight of the semiconductive shield composition.

Non-limiting examples of curing/crosslinking agents are: dicumyl peroxide; bis(alpha-t-butyl peroxyisopropyl)benzene; isopropylcumyl t-butyl peroxide; t-butylcumylperoxide; di-t-butyl peroxide; 2,5-bis(t-butylperoxy)2,5-dimethylhexane; 2,5-bis(t-butylperoxy)2,5-dimethylhexyne-3; 1,1-bis(t-butylperoxy)3,3,5-trimethylcyclohexane; isopropylcumyl cumylperoxide; di(isopropylcumyl)peroxide; and mixtures thereof. Peroxide curing agents can be used in amounts of about 0.1 to about 5 percent by weight based on the weight of the composition.

The semiconductive shield composition may be manufactured using conventional machinery and methods. The compositions may be prepared by batch or continuous mixing processes such as those well known in the art. For example, equipment such as Banbury mixers, Buss cokneaders, and twin screw extruders may be used to mix the ingredients of the formulation. The components of the semiconductive shield composition may be mixed and formed into pellets for future use in manufacturing insulated electrical conductors.

For crosslinkable compositions, the crosslinking agent may be mixed with the other components in one step. Alternatively, the crosslinking agent may be added in a second mixing step or absorbed into the polymer mass after mixing.

In this embodiment, the insulated electrical cable can further include (c) an insulating layer, (d) a grounded metal wire or tape, and (e) a jacket.

The insulating layer may be any conventional electrical insulators. Suitable electrical insulators used in medium voltage cables include polyethylenes, crosslinked polyethylenes (XLPE), ethylene-propylene rubbers and ethylene propylene diene rubbers (EPDM rubbers).

The semiconductive shield is conventionally formed directly over the inner electrically conductive core as a semiconductive conductor shield or over an insulating layer as a semiconductive insulation shield.

In another embodiment, the present disclosure provides a method of manufacturing an insulated electrical cable. It includes the steps of (a) compounding a butene-1 polymer composition comprising a butene-1 polymer having at least about 75 weight percent, based upon the total weight of the butene-1 polymer, of butene-1 derived units and having a flexural modulus of at most 60 MPa with an ethylene copolymer and a conductive carbon black composition which is present in an amount sufficient to give the semiconductive shield a resistance below about 550 ohm-meter to form a semiconductive shield composition, (b) extruding a semiconductive shield over an electrically conductive core from the semiconductive shield composition, and (c) extruding an insulation layer over the semiconductive shield. The semiconductive composition may have any of the additional components previously described admixed with the butene-1 polymer composition, the ethylene copolymer composition, and the conductive carbon black composition.

The method of manufacturing an insulated electrical cable can further include the step of (d) extruding a second semiconductive layer over the insulation layer. The second semiconductive composition may have any of the additional components previously described admixed with the butene-1 polymer composition, the ethylene copolymer composition, and the conductive carbon black composition.

In yet another embodiment, the present disclosure provides a second method of manufacturing an insulated electrical cable. It includes the steps of (a) extruding a semiconductive shield over an electrically conductive core from a semiconductive shield composition and (b) extruding an insulation layer over the semiconductive shield. The semiconductive composition is the composition previously described.

The method of manufacturing an insulated electrical cable may also include the steps of (c) extruding an insulation shield over the insulation layer and (d) curing the semiconductive shield, the insulation layer, and the insulation shield to form an insulated electrical cable. In this method, the insulation shield is preferably semiconductive and made from and/or contains a semiconductive shield as previously described. The semiconductive conductor shield and the semiconductive insulation shield may or may not be made from and/or contain the same semiconductive shield composition.

In a yet another embodiment, the present disclosure provide a third method of manufacturing an insulated electrical cable. It includes the steps of (a) extruding a semiconductive shield over an electrically conductive core from a semiconductive shield composition, (b) extruding an insulation layer over the semiconductive shield, (c) extruding an insulation shield over the insulation layer, (d) wrapping the insulation shield with metal wire or metal strips, and (e) placing a jacket over the metal wire or strips. The semiconductive composition is the composition previously described.

In this method, the insulation shield is preferably semiconductive and made from and/or contains a semiconductive shield as previously described. The semiconductive conductor shield and the semiconductive insulation shield may or may not be made from and/or contain the same semiconductive shield composition.

The electrical cable of the invention can be made by any of the methods well known in the art including (a) coating a metal conductor with a semiconductive layer, (b) in a double-extrusion crosshead extruding the insulating layer and the semiconductive shield together in a simultaneous extrusion, or (c) using a triple extrusion crosshead to simultaneously extrude a semiconductive layer around a metal conductor, an insulating layer around the semiconductive layer and a strippable semiconductive shield around the insulating layer.

In a two-pass extrusion process (dual-tandem extrusion), the conductor shield and insulation are first extruded in tandem and crosslinked prior to extruding and crosslinking the semiconductive insulation shield layer. Alternatively, a tandem extrusion process may be carried out in which the conductor shield is first extruded, followed by extrusion of the insulation and insulation shield in a dual extrusion head.

A single-step (true-triple) extrusion method is preferred because it minimizes the number of manufacturing steps and contamination between the cable's layers. True-triple extrusion prevents dust from settling on the shield surface between the conductor shield and the insulation/insulation shield extruder heads.

In a yet another embodiment, the present disclosure provides a method of making a medium voltage electric power cable having a semiconductive shield. The steps include simultaneously (a) extruding through a double extrusion crosshead onto a semiconductive layer encasing a metal conductor from a semiconductive shield composition, (i) an insulating layer encasing the semiconductive layer and (ii) a semiconductive layer encasing the insulating layer, (b) wrapping the semiconductive layer with metal wire or metal strips, and (c) placing a jacket over the metal wire or strips. The semiconductive composition is the composition previously described.

In a yet another embodiment, the present disclosure provides a method of making a medium voltage electric power cable having a semiconductive shield. The steps include simultaneously (a) extruding through a triple extrusion crosshead (i) a semiconductive layer encasing a metal conductor from a semiconductive shield composition, (ii) an insulating layer encasing the semiconductive layer, and (iii) a semiconductive layer encasing the insulating layer, (b) wrapping the semiconductive layer with metal wire or metal strips, and (c) placing a jacket over the metal wire or strips. The semiconductive composition is the composition previously described.

### EXAMPLES

The following non-limiting examples illustrate the invention.

The following materials were used to prepare the semiconductive shield compositions and the corresponding semiconductive shields for testing: General Cable LS567™ semiconductive conductor shield composition, General Cable LS571™ semiconductive insulation shield composition, and LyondellBasell PB0800™ polybutene-1. PB0800™ polybutene-1 is an isotactic, semi-crystalline homopolymer.

The materials were admixed in the weight percents shown in Table 1 on a Brabender at temperatures below 140 degrees Celsius for a mix cycle of seven (7) minutes. Next, the mixtures were pelletized. Subsequently, the pellets were extruded at about 138 degrees Celsius (280 degrees Farenheit) to make 7-mil thick tapes on a cast line. The tapes were cut into 1.0 inch wide×3-4 inch long strips and sealed at a temperature of greater than about 140 degrees Celsius to these substrates: (a) LDPE tapes, (b) aluminum tapes, and (c) copper tapes.

TABLE 1

| Component | Comp. Ex. 1 | Ex. 2 | Ex. 3 | Comp. Ex. 4 | Ex. 5 |
|---|---|---|---|---|---|
| LS567 | 100 | 99 | 95 | | |
| LS571 | | | | 100 | 95 |
| PB0800 | 0 | 1 | 5 | 0 | 5 |

Tables 2-5 show T-Peel test results based upon specimens having an LDPE insulation substrate. The semiconductive shield layers were 7 mil thick. The seal pressures were 40 psi, and the dwell times were 3 seconds.

For Table 2, the seal temperature was 146 degrees Celsius. All specimens had clean pulls.

TABLE 2

| Test | C. Ex. 1 | Ex. 2 | Ex. 3 | C. Ex. 4 | Ex. 5 |
|---|---|---|---|---|---|
| T-Peel (lb/f) | 0.162 | 0.147 | 0.112 | 0.791 | 0.158 |

For Table 3, the seal temperature was 150 degrees Celsius. All specimens had clean pulls.

TABLE 3

| Test | C. Ex. 1 | Ex. 2 | Ex. 3 | C. Ex. 4 | Ex. 5 |
|---|---|---|---|---|---|
| T-Peel (lb/f) | 0.159 | 0.135 | 0.098 | 0.803 | 0.128 |

For Table 4, the seal temperature was 160 degrees Celsius. Most specimens had clean pulls; however, Comparative Example No. 4 showed specimens that tore the LDPE substrate, had slight elongation, or tore the film.

TABLE 4

| Test | C. Ex. 1 | Ex. 2 | Ex. 3 | C. Ex. 4 | Ex. 5 |
|---|---|---|---|---|---|
| T-Peel (lb/f) | 0.169 | 0.192 | 0.164 | 4.205 | 0.405 |

For Table 5, the seal temperature was 170 degrees Celsius. Most specimens had clean pulls; however, Comparative Example No. 4 and Ex. 5 showed specimens that harmed the substrate or the film.

TABLE 5

| Test | C. Ex. 1 | Ex. 2 | Ex. 3 | C. Ex. 4 | Ex. 5 |
|---|---|---|---|---|---|
| T-Peel (lb/f) | 0.256 | 0.222 | 0.276 | 8.436 | 1.600 |

Comparative Example No. 1, Example 2, and Example 3 (insulation shields) were tested at temperatures of 190 degrees Celsius, 210 degrees Celsius, 230 degrees Celsius, and 250 degrees Celsius. All specimens continued to demonstrate clean pulls. None of the T-Peel measurements exceeded 0.340 lb/f.

Tables 6 and 7 show test results based upon specimens having an aluminum substrate. The semiconductive shield layers were 7 mil thick. The seal pressures were 40 psi, and the dwell times were 3 seconds.

For Table 6, the seal temperature was 170 degrees Celsius. Most specimens had clean pulls; however, Comparative Example No. 4 and Ex. 5 did not adhere to the aluminum substrate (DNS—did not stick).

TABLE 6

| Test | C. Ex. 1 | Ex. 2 | Ex. 3 | C. Ex. 4 | Ex. 5 |
|---|---|---|---|---|---|
| T-Peel (lb/f) | 0.140 | 0.171 | 0.181 | DNS | DNS |

For Table 7, the seal temperature was 190 degrees Celsius. Most specimens had clean pulls; however, Comparative Example No. 4 and Ex. 5 did not adhere to the aluminum substrate (DNS—did not stick).

TABLE 7

| Test | C. Ex. 1 | Ex. 2 | Ex. 3 | C. Ex. 4 | Ex. 5 |
|---|---|---|---|---|---|
| T-Peel (lb/f) | 0.156 | 0.181 | 0.167 | DNS | DNS |

Comparative Example No. 1, Example 2, Example 3, Comparative Example 4, and Example 5 were further tested at temperatures of 210 degrees Celsius and 230 degrees Celsius. Comparative Example No. 1, Example 2, and Example 3 continued to demonstrate clean pulls. None of the T-Peel measurements exceeded 0.240 lb/f. Comparative Example No. 4 began demonstrating adhesion at 230 degrees Celsius while Example No. 5 began demonstrating adhesion at 210 degrees Celsius.

Tables 8-10 show test results based upon specimens having a 10-mil copper substrate. The semiconductive shield layers were 7 mil thick. The seal pressures were 40 psi, and the dwell times were 3 seconds.

For Table 8, the seal temperature was 190 degrees Celsius. Specimens had clean pulls; however, one of the three Comparative Example No. 1 specimens did not adhere to the copper substrate.

TABLE 8

| Test | C. Ex. 1 | Ex. 2 | Ex. 3 |
|---|---|---|---|
| T-Peel (lb/f) | 0.21 | 0.225 | 0.216 |

For Table 9, the seal temperature was 210 degrees Celsius. Only specimen of Comparative Example No. 1 adhered to the copper substrate; the other specimen did not adhere to the copper substrate.

TABLE 9

| Test | C. Ex. 1 | C. Ex. 4 | Ex. 5 |
|---|---|---|---|
| T-Peel (lb/f) | 0.231 | DNS | DNS |

For Table 10, the seal temperature was 260 degrees Celsius. Most specimens had clean pulls; however, Example No. 3 did not maintain its stability.

TABLE 10

| Test | C. Ex. 1 | Ex. 2 | Ex. 3 | C. Ex. 4 | Ex. 5 |
|---|---|---|---|---|---|
| T-Peel (lb/f) | 0.349 | 0.235 | 0.384 | 0.165 | 0.116 |

What is claimed is:

1. An insulated electrical cable comprising
(a) an electrically conductive core and
(b) a semiconductive shield comprising
(i) a butene-1 polymer composition comprising a butene-1 polymer having at least about 75 weight percent, based upon the total weight of the butene-1 polymer, of butene-1 derived units and having a flexural modulus of at most about 60 MPa,
(ii) an ethylene copolymer composition, and
(iii) a conductive carbon black composition, which is present in an amount sufficient to give the semiconductive shield a resistance below about 550 ohm-meter,
wherein the semiconductive shield being formed over the electrically conductive core.

2. The insulated electrical cable of claim 1 further comprising
(c) an insulating layer,
(d) a grounded metal wire or tape, and
(e) a jacket.

3. The insulated electrical cable of claim 1 wherein the butene-1 polymer composition comprising a butene-1 polymer (bi) is selected from the group consisting of
(biA) a first butene-1 polymer (B1) being a butene-1 homopolymer or copolymer of butene-1 with at least another α-olefin, having a percentage of isotactic pentads from about 25 to about 55 percent;
(biB) a second butene-1 polymer (B2) being a butene-1/ethylene copolymer having a percentage of isotactic pentads of at least about 96 percent, and a total content of ethylene units in the range of about 10 to about 25 mol percent; and
(biC) a third butene-1 polymer (B3) being a butene-1 polymer having a distribution of molecular weights (Mw/Mn) measured by GPC lower than about 3 and at least one of the following properties:
(biC1) no melting point (TmII) that is detectable in the DSC thermogram and
(biC2) a measurable melting enthalpy (ΔHf) after aging.

4. The insulated electrical cable of claim 1 wherein the ethylene copolymer composition (iii) comprises a linear, single-site catalyzed polymer comprising ethylene polymerized with at least one comonomer selected from the group consisting of C3 to C20 alpha-olefins and optionally, the semiconductive shield composition further comprises
(iv) LDPE, wherein the component in (iii) is different from the component in (iv).

5. The insulated electrical cable of claim 1 wherein the ethylene copolymer composition (iii) comprises a base polymer selected from the group consisting of
(A) ethylene vinyl acetate copolymers,
(B) ethylene alkyl acrylate copolymers wherein the alkyl group is selected from C1 to C6 hydrocarbons,
(C) ethylene alkyl methacrylate copolymers wherein the alkyl group is selected from C1 to C6 hydrocarbons, and
(D) ethylene alkyl acrylate alkyl methacrylate terpolymers wherein the alkyl group is independently selected from C1 to C6 hydrocarbons;
and wherein the semiconductive shield composition further comprises
(iv) an adhesion-modifying compound different from the base polymer, selected from the group consisting of
(A) ethylene vinyl acetate copolymers,
(B) ethylene alkyl acrylate copolymers wherein the alkyl group is selected from C1 to C6 hydrocarbons, and
(C) ethylene alkyl methacrylate copolymers wherein the alkyl group is selected from C1 to C6 hydrocarbons,
with the adhesion-modifying compound having a molecular weight greater than about 20,000 daltons and a polydispersity greater than about 2.5

6. A method of manufacturing an insulated electrical cable comprising the steps of
(a) extruding a semiconductive shield over an electrically conductive core from a semiconductive shield composition comprising
(i) a butene-1 polymer composition comprising a butene-1 polymer having at least about 75 weight percent, based upon the total weight of the butene-1 polymer, of butene-1 derived units and having a flexural modulus of at most about 60 MPa,
(ii) an ethylene copolymer composition, and
(iii) a conductive carbon black composition, which is present in an amount sufficient to give the semiconductive shield a resistance below about 550 ohm-meter, and
(b) extruding an insulation layer over the semiconductive shield.

7. The method of manufacturing an insulated electrical cable of claim 6 further comprising the steps of
(c) extruding an insulation shield over the insulation layer and
(d) curing the semiconductive shield, the insulation layer, and the insulation shield to form an insulated electrical cable.

8. The method of manufacturing an insulated electrical cable of claim 7 wherein the insulation shield comprises the semiconductive shield composition.

9. The method of manufacturing an insulated electrical cable of claim 6 further comprising the steps of
(c) extruding an insulation shield over the insulation layer,
(d) wrapping the insulation shield with metal wire or metal strips, and
(e) placing a jacket over the metal wire or strips.

10. The method of manufacturing an insulated electrical cable of claim 9 wherein the insulation shield comprises the semiconductive shield composition.
